(19) United States
(12) Patent Application Publication
(10) Pub. No.: US 2008/0148236 A1
(43) Pub. Date: Jun. 19, 2008

(54) TEST DEVICE, METHOD, AND COMPUTER READABLE MEDIUM FOR DERIVING A QUALIFIED TEST CASE PLAN FROM A TEST CASE DATABASE

(75) Inventors: Wei-Jui Huang, Kaohsiung County (TW); Chiu-Han Hsiao, Keelung (TW); Farn Wang, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/682,603

(22) Filed: Mar. 6, 2007

(30) Foreign Application Priority Data
Dec. 15, 2006 (TW) 095147239

(51) Int. Cl. G06F 11/36

(52) U.S. Cl. 717/124

(57) ABSTRACT

A test device, connecting to a test case database, derives a qualified test case plan from the test case database, a method and a computer readable medium are disclosed. The test device comprises a rule module, a selection module, and a modulation module. The rule module is adapted to setting a plurality of test rules. The selection module is adapted to selecting a proper test case meeting the requirement of a particular test rule, and to selecting proper test case for every test rule. The selection module is also adapted to building a binary decision diagram of the proper test cases. The modulation module is adapted to deriving the qualified test case plan corresponding to the binary decision diagram, wherein the qualified test case plan comprises at least one proper test case.

This application claims priority to Taiwan Patent Application No. 095147239 filed on Dec. 15, 2006.

### CROSS-REFERENCES TO RELATED APPLICATIONS

Not applicable.

### BACKGROUND OF THE INVENTION

1. Field of the Invention

The present invention relates to a test device, a method, and a computer readable medium; specifically, it relates to a test device, a method, and a computer readable medium for deriving a qualified test case plan from a test case database

2. Descriptions of the Related Art

In development of any software, it comprises a stage of testing prototypal software. Conventional test method is used to choose proper test cases from a test case database by manpower, and to arrange the proper test cases in a qualified set of test cases. Another method is to develop a specific test case only for the single software. There is no system that can automatically generate qualified test case according to different demands.

Taking choosing proper test cases by manpower as an example, due to subjective or careless situations, the chosen test cases may not completely fit requirement of testing conditions, and results in failed testing result. To enhance accuracy of above method, it requires large manpower and much time. On the other hand, developing a specific test case only for the single software depends on experienced testing engineers. The aforementioned situations increase testing difficulty and cost.

Conventional software for testing communication protocol is generally only a support software of commercial package software, and can barely be applied in testing complex software configured for communication protocol.

Thus, how to design a system for automatically generating test cases according to different requirement of software is still an objective for the industry to endeavor.

### SUMMARY OF THE INVENTION

The primary objective of this invention is to provide a test apparatus connecting to a test case database for selecting a qualified test case plan from the test case database. The test apparatus comprises a rule module, a selection module, and a modulation module. The rule module is configured for setting a plurality of test rules. The selection module is configured for selecting proper test case according to each of the test rules and deriving a binary decision diagram of the proper test cases. The modulation module is configured for selecting a qualified test case plan according to the binary decision diagram, and the qualified test case plan comprises at least one proper test case.

Another objective of this invention is to provide a test method for selecting a qualified test case plan from a test case database, the test method comprising steps of: setting a plurality of test rules; selecting proper test case according to each of the test rules; deriving a binary decision diagram of the proper test cases; and selecting a qualified test case plan according to the binary decision diagram, the qualified test case plan comprising at least one proper test case.

Yet a further objective of this invention is to provide a computer readable medium storing a computer program to execute a method for electing a qualified test case plan from a test case database, the test method comprising steps of: setting a plurality of test rules; selecting proper test case according to each of the test rules; deriving a binary decision diagram of the proper test cases; and selecting a qualified test case plan according to the binary decision diagram, the qualified test case plan comprising at least one proper test case.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is the first embodiment of the present invention;

FIG. 2 is a binary decision diagram of selected qualified test cases;

FIG. 3 is the second embodiment of the present invention; and

FIG. 4 is the third embodiment of the present invention.

### DESCRIPTION OF THE PREFERRED EMBODIMENT

The present invention can automatically choose a qualified test case plan from a test case database. The test case database comprises a plurality of test cases to fit different testing requirements of different objects.

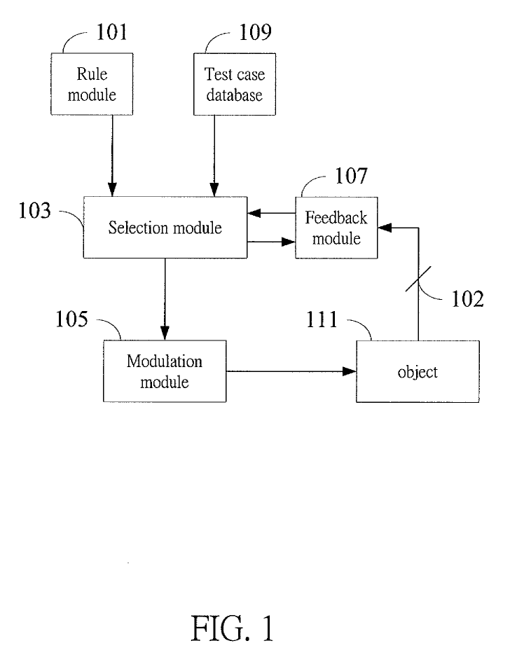

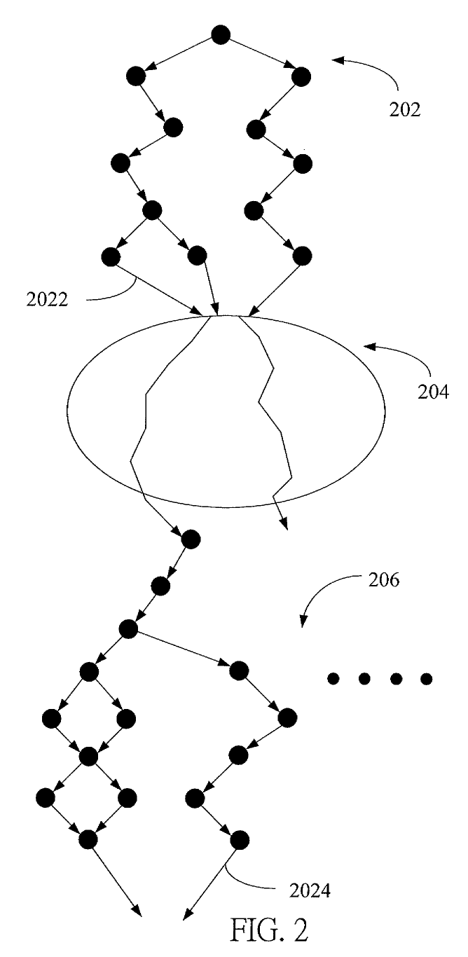

FIG. 1 shows the first embodiment of the present invention, which is a test device comprising a rule module 101, a selection module 103, a modulation module 105 and a feedback module 107. The test device connects to a test case database 109, which comprises a plurality of test cases. Also referring to FIG. 2, which shows a binary decision diagram of selected qualified test cases, it comprises three binary decision sub-diagrams separately as sub-diagram 202, sub-diagram 204, and sub-diagram 206.

The rule module 101 defines binary expression of the test cases containing in the test case database 109. In the present embodiment, it applies six-digital binary expression to represent different test cases. For example, the 21st test case in the test case database 109 is represented in 010101 and denoted as path 2022 in the sub-diagram 202. The first bit of the six-digital binary expression means 2⁰, the second bit means 2¹, and the sixth bit means 2⁵ by the same principle. Therefore, the six-digital binary expression can represent sixty-four test cases. If the number of test cases increases, the binary expression also increases in its digital bits to fit the requirement. The rest cases are in universal formats, such as TTCN-3 format.

The rule module 101 is also configured to set a plurality of test rules for choosing proper test case in response to each test rule by the selection module 103. Then the rule module 101 derives a binary decision diagram according to those chosen proper test cases. The rule module 101 can set any number of test rules according to user's demand. In the embodiment, the rule module 101 sets two test rules, named as first rule and second rule. Each rule comprises a pre-condition and a post-condition. Taking the first rule as an example, it comprises a first pre-condition of requiring a test case with “T2 start” event, wherein “T2 start” means the object should start at time T2. The first rule also comprises a second pre-condition of requiring a test case with execution time less than five seconds, and a post-condition of requiring a test case with receiving “T2 timeout” events, wherein “T2 timeout” means the object should be able to timeout at time T2. The second rule only comprises a third pre-condition of requiring a test case with memory usage percentage less than 30%.

The rule module 101 then chooses proper test cases according to the first and second rules, and the result is shown below in table 1.

TABLE 1

| | | Sub-diagram 202 | Sub-diagram 204 | Sub-diagram 206 |
|---|---|---|---|---|
| rule | First rule | T2 start | Execution time less | receiving T2 timeout |
| | | | than 5 seconds | |
| | Second | no | Memory usage | no |
| | rule | | percentage less than | |
| | | | 30% | |

| | | | |
|---|---|---|---|
| Chosen test case | 21, 22, 42 | 0, 1, 2, 3, 4 seconds | 11, 21, 50 |
| | | 0%~29% | |
| Binary expression of | 010101, | AA0000B, AA0001B | 00001011, |
| test case | 010110, | AA0010B, AA0011B | 00010101, |
| | 101010 | AA0100B, | 00110010 |

The sub-diagram 204 represents categories of test results, and it is divided into four categories with execution time from 0 to 10 seconds, in integral, and memory usage percentage from 0% to 100%, in integral. Thus the sub-diagram needs fourteen bits, Z0 to Z13, to represent possible results. Z0 to Z2 mean categories, Z3 to Z6 mean execution time, and Z7 to Z13 mean memory usage percentage. In considering first rule, it only takes execution time as a pre-condition, therefore AA of the binary expression AA0000B means that the categories are unnecessary to consider, B of the binary expression means that the memory usage percentage is unnecessary to consider, and 0000 means that the execution time is 0 second. Similarly, the rest binary expression of the sub-diagram 204 can be realized in the same way.

The binary expression of the sub-diagram 206 comprises eight bits, the first two bits means the test rule applied to select the test case. For example, 00001011 means the 11^{th} test case is selected by the first rule. Similarly, the rest binary expression of the sub-diagram 206 can be realized in the same way.

In the present invention, after the test cases fitting the first rule are selected, the modulation module 105 applies the selected test case to test the object 111. For example the test case 50 is selected and expressed in 00110010, the test case 50 is denoted as a path 2024 in the sub-diagram 206. The modulation module 105 applies the test case 50 to test the object 111 and derives a temporary test result 102. The feedback module 107 then rearranges the sub-diagram 204 according to the temporary test result 102. More specifically, the feedback module 107 processes the test result 102 and the original sub-diagram 204 together in logic methodology, then joins the test result 102 into the sub-diagram 204 to derive the rearranged sub-diagram 204. In the embodiment, the temporary test result 102 can be stored in XML format and be accessed and searched by a program language in Xquery format.

Then the test device continuously selects other proper test cases satisfying other test rules from the test case database 109. In the present embodiment, after the selection module 103 executes the pre-condition, it will obtain the test rule with the post-condition which has not been processed yet, and continues in selecting test cases in turns. And the modulation module 105 arranges the selected test cases in a qualified test case plan for completely testing the object 111. The test result can also be stored in XML format

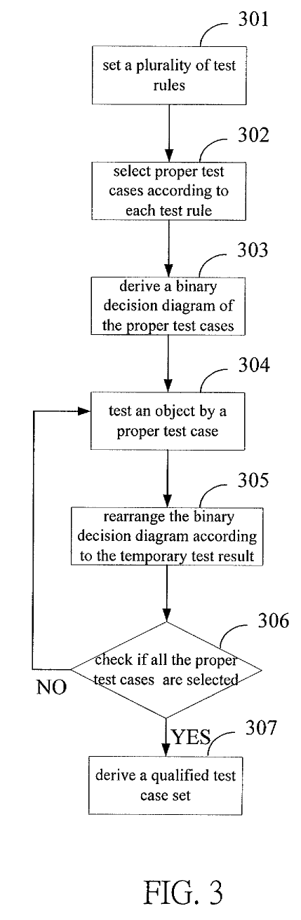

FIG. 3 shows the second embodiment of the present invention, which is a method for selecting a qualified test cast set from a test case database.

At first, the step 301 is executed to set a plurality of test rules. In the second embodiment, two test rules, i.e. first rule and second rule, are set. Each of the rules comprises pre-condition and post-condition. Then step 302 is executed to select proper test cases according to each test rule. More specifically, the step 302 is executed to select proper test cases according to the pre-condition of the first rule, and select proper test cases according to the post-condition of the first rule. The step 303 is executed to derive a binary decision diagram of the proper test cases, wherein the binary decision diagram comprises at least one sub-diagram of proper test cases selected by the pre-condition, and at least one sub-diagram of proper test cases selected by the post-condition.

The step 304 is executed to test an object by a proper test case selecting from the binary decision diagram and derive a temporary test result. In the present embodiment, the selected proper test case is the one fits in the first rule. Then step 305 is executed to rearrange the binary decision diagram according to the temporary test result. More specifically, in the present embodiment, the temporary test result is processed with the sub-diagram derived from precondition together in logic methodology, then the temporary test result is joined into the sub-diagram to derive the rearranged binary decision diagram.

Then step 306 is executed to check if all the proper test cases fitting every test rule are selected. If the checked result is negative, then step 304 and 305 are executed again to select the rest proper test cases. In the present embodiment, it only comprises two test rules, thus only the second rule needs to be further considered for selecting proper test cases. Then the step 304 is executed to select proper test case according to the test rule which has not been processed yet.

The step 307 is executed to derive a qualified test case plan according to all the selected proper test cases. Since one proper test case may fit a plurality of test rules, the qualified test case plan comprises at least one proper test case. It means that the number of proper test cases contained in the qualified test case plan is less or equal to the number of the test rules. The qualified test case plan can be executed to completely test the object.

In addition to the steps shown in FIG. 3, the second embodiment is able to execute all of the operations or functions noted in the first embodiment. People skilled in the art can clearly understand how the second embodiment being able to execute, and redundant description is omitted.

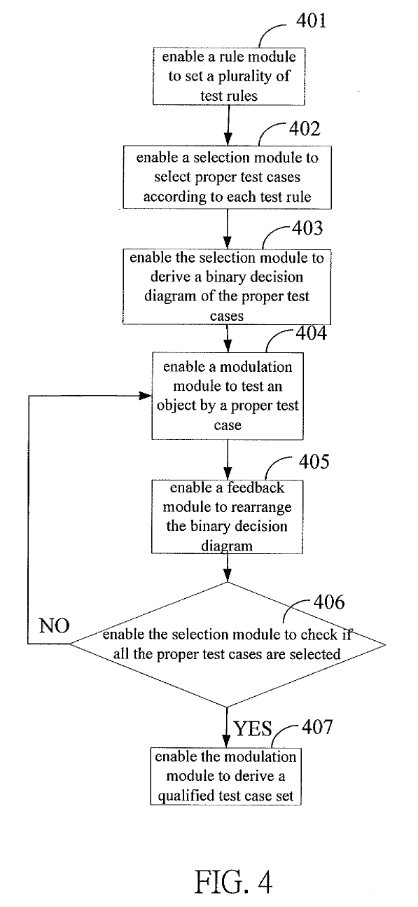

FIG. 4 shows the third embodiment of the present invention, which is a test method applied in a test device. The test device can be the one as described in the first embodiment. More specifically, the third embodiment applies a computer program to control the test device. The third embodiment can be applied to select a qualified test case plan fitting all test rules from a test case database.

At first, the step 401 is executed to enable a rule module to set a plurality of test rules. In the embodiment, two test rules, i.e. first rule and second rule, are set. Each of the rules comprises pre-condition and post-condition. Then step 402 is executed to enable a selection module to select proper test cases according to each test rule. More specifically, the step 402 is executed to enable the selection module to select proper test cases according to the pre-condition of the first rule, and select proper test cases according to the post-condition of the first rule. The step 403 is executed to enable the selection module to derive a binary decision diagram of the proper test cases, wherein the binary decision diagram comprises at least one sub-diagram of proper test cases selected by the pre-condition, and at least one sub-diagram of proper test cases selected by the post-condition.

The step 404 is executed to enable a modulation module to test an object by a proper test case selecting from the binary decision diagram and derive a temporary test result. In the present embodiment, the selected proper test case is the one fits in the first rule. Then step 405 is executed to enable a feedback module to rearrange the binary decision diagram according to the temporary test result. More specifically, in the present embodiment, the temporary test result is processed with the sub-diagram derived from pre-condition together in logic methodology, and then the temporary test result is joined into the sub-diagram to derive the rearranged binary decision diagram.

Then step 406 is executed to enable the selection module to check if all the proper test cases fitting every test rule are selected. If the checked result is negative, then step 404 and 405 are executed again to select the rest proper test cases. In the present embodiment, it only comprises two test rules, thus only the second rule needs to be further considered for selecting proper test cases. Then the step 404 thus is executed to select proper test case according to the test rule which has not been processed yet.

The step 407 is executed to enable the modulation module to derive a qualified test case plan according to all the selected proper test cases. Since one proper test case may fit a plurality of test rules, the qualified test case plan comprises at least one proper test case. It means that the number of proper test cases contained in the qualified test case plan is less or equal to the number of the test rules. The qualified test case plan can be executed to completely test the object.

Each of the aforementioned methods can use a computer readable medium for storing a computer program to execute the aforementioned steps. The computer readable medium can be a floppy disk, a hard disk, an optical disc, a flash disk, a tape, a database accessible from a network or a storage medium with the same functionality that can be easily thought by people skilled in the art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A test apparatus connecting to a test case database for selecting a qualified test case plan from the test case database, comprising:
a rule module configured for setting a plurality of test rules;
a selection module configured for selecting proper test case according to each of the test rules and deriving a binary decision diagram of the proper test cases; and
a modulation module configured for selecting a qualified test case plan according to the binary decision diagram, the qualified test case plan comprising at least one proper test case.

2. The test apparatus as claimed in claim 1, further comprising:
a feedback module configured for rearranging the binary decision diagram according to a temporary test result of an objects;
wherein the modulation module test the object according to at least one of the proper test cases to derive the temporary test result.

3. The test apparatus as claimed in claim 1, wherein the test cases are in TTCN-3 format.

4. The test apparatus as claimed in claim 2, wherein the temporary test case is in XML format.

5. A test method for selecting a qualified test case plan from a test case database, the test method comprising steps of:
setting a plurality of test rules;
selecting proper test case according to each of the test rules;
deriving a binary decision diagram of the proper test cases; and
selecting a qualified test case plan according to the binary decision diagram, the qualified test case plan comprising at least one proper test case.

6. The test method as claimed in claim 5, further comprising steps of:
testing an object according to at least one of the proper test cases to derive a temporary test result; and
rearranging the binary decision diagram according to the temporary test result.

7. The test method as claimed in claim 5, wherein the test cases are in TTCN-3 format.

8. The test apparatus as claimed in claim 6, wherein the temporary test case is in XML format.

9. A computer readable medium storing a computer program to execute a method for electing a qualified test case plan from a test case database, the test method comprising steps of:
setting a plurality of test rules;
selecting proper test case according to each of the test rules;
deriving a binary decision diagram of the proper test cases; and
selecting a qualified test case plan according to the binary decision diagram, the qualified test case plan comprising at least one proper test case.

10. The computer readable medium as claimed in claim 9, wherein the test method further comprises steps of:
testing an object according to at least one of the proper test cases to derive a temporary test result; and
rearranging the binary decision diagram according to the temporary test result.

11. The computer readable medium as claimed in claim 9, wherein the test cases are in TTCN-3 format.

12. The computer readable medium as claimed in claim 10, wherein the temporary test result is in XML format.
